(19) United States
(12) Patent Application Publication
(10) Pub. No.: US 2002/0172737 A1
(43) Pub. Date: Nov. 21, 2002

(54) Foodstuff for and method of feeding aquatic life

(76) Inventors: Joseph Pinski, St. Paul, MN (US); Bradley Thorud, Ramsey, MN (US); Phillip L. Fischer, Blaine, MN (US); Daniel F. Villamar, Damascus, MD (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/801,937

(22) Filed: Mar. 8, 2001

(51) Int. Cl. A01K 1/00

(52) U.S. Cl. 426/2

(57) ABSTRACT

A solid particulate foodstuff for aquatic life having a high moisture content. The foodstuff includes an oil-coated nutrient feed particulate embedded in a gel and an antimicrobial agent.

The present invention relates to a solid particulate foodstuff for feeding aquatic life. More particularly, the present invention relates to a solid, foodstuff which is not in a flowing liquid medium. The particulate foodstuff has a high moisture content, is structurally acceptable to various species of aquatic life and has a long shelf life.

### BACKGROUND

Aquaculture has become an increasingly significant contributor to the world's seafood supply. Aquaculture operations occur worldwide with a large concentration of such operations occurring in Asia. Typical aquaculture operations take place in contained ponds which are seeded with crustaceans, fish or shellfish. Seed stock is supplied to sophisticated aquafarms by aquaculture systems in which the environment of the contained pond is artificially controlled to provide optimum growth conditions. An increasing demand for seafood products and limits on the amount of seed stock available in nature has created the need for increased production efficiencies in crustacean, shellfish and finfish hatchery and nursery facilities. A critical factor effecting these aquaculture operations is the feeding process.

Conventional aquatic larval feeds are provided in a dry form as powdered or flaked feeds which have low moisture content. They generally are poor supplements where preservation of water quality is important. Dry feeds are either added directly to an aquaculture system or mixed with water prior to use. Conventional dry feeds rapidly deteriorate in tank water, with physical decomposition and breakdown of the dry feed starting immediately with wet mixing. The large immediate decomposition that takes place when preparing and using dry feeds results in a significant contamination of culture tank water. With commercial feeding programs that depend on dry and prepared feeds such as flakes, powders and egg custards, the concentration of decomposing organic matter in culture tank water increases as feeding rates increase resulting in high levels of toxic ammonia and other pollutants. The resulting unhealthy water conditions contribute to the proliferation of pathogens including protozoan fouling organisms such as Zoothanmium, thus reducing the overall productivity of the tank.

Stages in the life cycle of certain aquatic organisms, such as shrimp, require critical attention and care in the feeding process. Feeding programs using dry feeds are difficult to automate, require expensive labor intensive practices, and are prone to feeding errors which affect the overall productivity of the system. Further, with the use of dry feeds, significant amounts of nutrients are frequently lost to the water and dry feeds are typically of a size that makes nutrients unavailable to certain aquatic organisms at specific times in their life cycles.

One approach to overcoming some of the disadvantages associated with dry feeds has been the development of micro-encapsulated diets. EP 237542 describes a system where a nutritional component is entrapped in a liposome and the liposome is further encapsulated in a hydro-colloid matrix. The resulting lipogel microcapsules were either stored as a freeze-dried powder or suspended in water containing chloramphenicol. Further, Villamar et al. (Marine Biology, 115:635 (1993)) describes the preparation of complex microcapsules (CXMs) consisting of dietary ingredients and lipid-wall microcapsules (LWMs) embedded in particles of a gelled mixture of alginate and gelatin to obtain a single food-particle type used to provide suspension feeders with dietary nutrients. CXMs were lyophilized and stored under nitrogen at −20° C.

It also has been suggested in WO 87/01587 that microcapsules using liposomes are useful to time deliver materials such as medications. These types of microcapsules, however, are based upon phospholipids which form a membrane around the medication which is subject to time release. This type of membrane or barrier is fragile, potentially expensive and difficult to make and would not likely remain a discrete microcapsule when combined with other materials which would desirably form an appropriate part of a feed for marine animals. Moreover, liposomes are capable of providing only low levels of feed for each liposome.

The micro-encapsulated feeds described in the art do not solve all of the problems associated with dry feeds. Production of nutrient in liposomes and their subsequent encapsulation in a hydrocolloid matrix is a labor intensive process which adds to the cost of the final feed. Freeze drying of micro-encapsulated feeds results in oxidation of the lipid component, providing a less desirable feed. Micro-encapsulated feeds that are stored in a lyophilized state still have some of the same disadvantages as described for dry feeds, as the lyophilized feed must still be rehydrated and manually introduced into a tank. Further, the micro-encapsulated feeds described in the prior art have not eliminated the water pollution problems associated with the use of dry feeds.

Another approach to providing a shelf stable feed is to provide a liquid coated feed, generally in an aqueous medium, as described in U.S. Pat. No. 5,698,246 to Villamar. The Villamar patent describes stabilizing feed in a liquid medium and did not account for different feeding habits of different aquatic species which range from feeding at surface of water versus bottom feeding. Moreover, the Villamar patent did not address the problem of the cost of shipping a liquid feed, which most often includes liquid water which as a part of the stabilized feed, and still maintain the shelf life and stability of the feed against molds and other types of spoilage.

### SUMMARY

The invention provides a solid, non-liquid particulate foodstuff composition which is effective for meeting the nutritional needs of aquatic life. The invention also is directed to a method for making the solid, non-liquid foodstuff and a method for feeding aquatic life, such as larval and post larval shrimp, and fish with the foodstuff of the invention. The foodstuff includes an enrobed particulate foodstuff in an antimicrobial environment which provides a nutritionally formulated ration for crustaceans and fish having a shelf life of at least about six months. The foodstuff of the invention includes oil-coated nutrient and moisturized nutrient feed particles which are embedded in a gel or an ingestible polymer blend. The gel is crosslinked or complexed to encapsulate the oil-coated nutrient feed to provide an encapsulated, oil-coated, moisturized nutrient feed. The oil coating and crosslinked gel coating maintain the moisturized nutrient feed particles in an aqueous aquatic environment and stabilize the nutrient feed particles without drying or freeze drying them.

The encapsulated, oil-coated, moisturized feed is stabilized against spoilage by exposing it to a liquid antimicrobial where the liquid antimicrobial is in an amount which provides an antimicrobial environment which stabilizes the encapsulated oil-coated feed against spoilage for at least about six months, but is an amount which does not make the feed flowable as a particulate feed in a liquid medium. With such a shelf life, the particulate foodstuff has an aerobic total plate count of less than about 10⁷ total microbes per gram after six months. Further, the aerobic total plate of microbes does not increase more than about 20% after about six months. Generally with this shelf life, total numbers of yeasts and molds is less than about 100 per gram after 6 months, and the numbers of yeast and molds present in the particulate foodstuff does not increase more than about 20%.

The oil-coated nutrient feed includes particulate nutrient feed, water and oil in and on the surface of the particulate nutrient feed. In one aspect, the oil-coated feed also includes endo-probiotic bacteria and/or ecto-probiotic bacteria. The endo-probiotic bacteria may aid the digestion of the aquatic animal whereas the ecto-probiotic bacteria may act to maintain water quality in the aquatic environment. The edible oil has a melting point below about 29° C. Typical oils include fish oil, peanut oil, olive oil, corn oil, coconut oil, sunflowerseed oil, cotton seed oil, soybean oil, rapeseed oil and palm oil. The particulate feed, water and oil are mixed, and the oil forms an inner coating for the particulate feed. The liquid oil, particulate feed and water are intimately mixed, such that the feed is coated with the oil, and the oil is at least on and/or into the surface of the feed. The water provides the oil-coated nutrient feed with a moisture content of at least about 20%, and generally from about 20 to about 70 weight percent water based upon the weight of the solid particulate, non-liquid foodstuff. In some cases the oil is substantially homogeneously dispersed throughout the nutrient feed particles. This is in contrast to microcapsules formed by liposomes lying as a fragile membrane over the surface of the feed. These liposome microcapsules can be fractured or destroyed in further processing or in a hostile aquatic environment. This destruction can release the contents inside the liposome, which in the case of an aquatic feed, would contaminate the aquatic environment.

The oil-coated moisturized nutrient feed is enrobed or encapsulated in an outer coating which is a crosslinked gelled matrix to provide a coated foodstuff. The gel provides a hydrocolloid matrix, and in one aspect, the hydrocolloid matrix is a gelled alginate or a blend of alginate and gelatin which alginate or blend is crosslinked to coat and in some cases impregnate the oil coated feed. This generally prevents the oil and gel coated feed from degrading in the aqueous environment of the aquatic animal for at least 24 hours such that the particulate generally remains in the same physical form as when it was originally added to the marine environment. The particulate foodstuff has a size range of from about 5 microns to a particle having a length of about 6 inches and a diameter of about 2 inches. Nutrients leached into the aqueous aquatic environment if not eaten by aquatic animals, will decompose and contaminate that environment. Such contamination results in increased levels of toxic ammonia and other pollutants.

The encapsulated or coated foodstuff is exposed to a liquid antimicrobial, such as propylene glycol, glycerol, propionic acid, and mixtures thereof. The liquid antimicrobial may be an aqueous solution of the aforedescribed salts. In one aspect, the antimicrobial may be a calcium salt of propionic acid, a sodium salt of propionic acid, an ammonium salt of propionic acid, acetic acid, a calcium salt of acetic acid, a sodium salt of acetic acid, citric acid, a calcium salt of citric acid, a sodium salt of citric acid, phosphoric acid, sorbic acid sodium benzoate, potassium benzoate, calcium benzoate, sorbic acid, potassium sorbate, sodium benzoate and mixtures thereof. In one aspect, the liquid antimicrobial is combined with a water soluble, multivalent, antimicrobial salt such as calcium chloride which acts as a cross linker for the alginate, as well as acts as an antimicrobial. The antimicrobials, both liquid and salt, in combined amounts are effective for stabilizing the feed for at least about 6 months, without the solid, non-liquid particulate foodstuff being in a flowable particulate in a liquid medium. This provides a particulate foodstuff that is shelf stable, is effective to provide a shelf life as described above, permits a range of sizes and bouyances to accommodate the feeding of different species of aquatic life, and is shipable in a cost-effective manner because the particulate foodstuff is not shipped as a part of a liquid medium.

The particulate foodstuffs of the invention are effective in a method for feeding aquatic life where the particulate foodstuff is added to the aquatic environment. As described, the particulate foodstuffs of the invention are stable in an aqueous environment for at least about 24 hours such that there is no significant leaching of nutrients into the aqueous environment after 24 hours.

### DETAILED DESCRIPTION

The foodstuff of the invention is made by preparing an oil-coated, moistured nutrient feed by mixing a particulate or powdered feed having a particle size of less than about 1000 μm, oil and water. In one aspect, powdered feed, endo-probiotic bacteria and/or ecto-probiotic bacteria, water and oil are mixed to provide a feed which not only can enhance the value of the feed for certain species of aquatic life, such as shrimp, but the release of such bacteria can help maintain a clean water environment. Generally, the oil-coated nutrient feed includes the powdered nutrient feed, from about 15 to about 70 weight percent, based on the weight of the particulate solid coated nutrient feed, from about 3 to about 30 weight percent oil, based on the weight of the particulate solid coated nutrient feed, and from about 20 to about 70 weight percent, water, based upon the weight of the particulate solid coated feed, and when the endo-probiotic and/or ecto-probiotic bacteria are present, from about 0.1 to about 5.0 weight percent, based upon the weight of the particulate solid coated feed, endo-probiotic and/or ecto-probiotic bacteria. The nutrient feed may also include from about 0 to about 5 weight percent, based upon the weight of the nutrient feed, emulsifier and from about 0 to about 150 ppm antioxidant. Emulsifiers such as Santone and lecithin may be used. Rendox is a commercially available antioxidant which may be used. The feed and other dry ingredients are blended before they are mixed with the water and oil. The oil serves to make the feed hydrophobic and is on and in the feed. Endo-probiotic bacteria which may be used in the product of the invention include dried B. licheniformis and B. subtilis strains commercially available from Cris Hansen's Biosystems.

The particulate nutrient feed may be adjusted for the requirements of the aquatic animal being fed as is known. For shrimp, the feed may include animal protein, brine shrimp, egg product, betaine, alanine, isoleucine, leucine, serine, valine, glycine, astaxanthin, vitamin A supplement, vitamin B12 supplement, riboflavin supplement, calcium pantothenate, niacin supplement, vitamin D3 supplement, vitamin E supplement, menadione sodium bisulfite complex, folic acid, biotin, thiamine, pyridoxine hydrochloride, inositol, choline chloride and oil. The particulate feed may also include medicaments. Generally, the oil has a melting point below about 29° C. Typical oils include fish oil, peanut oil, olive oil, corn oil, sunflowerseed oil, cotton seed oil, soybean oil, rapeseed oil, coconut oil and palm oil. Heating of the oils or particulate feed may be used to maintain the oils in a liquid state for uniform coverage. In an important aspect of the invention, the oil provides the Omega-3 HUFA (highly unsaturated fatty acid) dietary requirements of aquatic shrimp and fish by providing EPA (eicosapentaenoic acid) and DHA (docosahexenoic acid).

A food in gel blend is made by embedding the oil-coated nutrient feed which has a moisture content of at least about 20% (based on the weight of the final product) into a gel which when crosslinked or complexed to encapsulate the oil-coated moisturized feed is effective to contain the oil-coated, moisturized nutrient feed in an aqueous environment. The particulate solid coated nutrient feed includes from about 15 to about 70 weight percent nutrient feed, from about 3 to about 30 weight percent oil, from about 0.5 to about 8 weight percent gel, from about 2 to about 16 weight percent crosslinking salt, from about 0.5 to about 4 antimicrobial, from about 0.1 to about 5 weight percent endo-probiotic and/or ecto-probiotic bacteria, and about 20 to about 70 weight percent water, where all weights are based on the total weight of the particulate solid coated nutrient feed.

The gel may be made from a complex coacervate of components, organic polymers, gums such as acacia (gum arabic) and carrageenan, sugar, such as maltodextrins and sucrose, ethyl cellulose, wax, fat or protein. The gel is complexed or crosslinked to provide hydrophobic properties to the oil-coated feed and must be ingestible by the aquatic animal. Particulate foodstuff formed has a particle size of from about 5 microns to a particle size having a length of about 6 inches and a diameter of about 2 inches. A “complexed coacervate” means an aggregate of colloidal droplets held together by electrostatic attractive forces. It is a mixture of polyelectrolytes which have an appropriate ionic charge and molecular chain lengths to encapsulate the oil-coated feed. The gel also may be a protein which upon crosslinking through in situ or interfacial polymerization will encapsulate the oil-coated feed. The protein also may be denatured to encapsulate the oil-coated food or may be made into microspheres to encapsulate the feed by solvent evaporation.

In one aspect of the invention, the hydrocolloid gel comprises alginate or a gelled blend of alginate, such as sodium alginate and polypeptides or proteins such as gelatin. The alginate or the alginate/gelatin blend are gelled in water. The ratio of alginate to gelatin is from about 5:1 to about 2.75:1. The protein or polypeptide provides sites opened by proteases which allows the aquatic animal to digest the feed. Crustaceans, such as shrimp, are capable of masticating the outer coating, such as the crosslinked alginate/gelatin blend, are benefitted by the protein in the outer coating and almost immediately are capable of consuming the oil-coated nutrient. The gel also may include a water soluble hexametaphosphate such as sodium hexametaphosphate, the alginate/gelatin/hexametaphosphate blend having a ratio in the range of from about 5:1:1 to about 2.75:1:0.5.

Processes known in the art that may be adapted for use in encapsulating the oil-coated, moisturized nutrient feed include complex coacervation (U.S. Pat. No. 2,800,457), polymer-polymer incompatibility (U.S. Pat. No. 3,341,416), interfacial and in situ polymerization (Wittbecker et al., J. Polym. Sci. 40:299 (1959); U.S. Pat. Nos. 3,577,515, 4,285,720, and 4,087,376), fluidized-bed and Wurster processes (Hall et al. Controlled Release Technologies: Methods, Theory and Applications, Vol. II, CRC Press, Inc., Boca Raton, Fla. (1980)), desolvation, solvent evaporation from emulsions, gelation, pressure extrusion, spray drying and congealing, coextrusion, vacuum coating, and electrostatic deposition, which are further described in Encyclopedia of Polymer Science and Engineering, Vol. 9, 2nd Ed. (1987).

In the aspect of the invention where the gel is the alginate/gelatin blend, the food in gel blend is made by blending the oil-coated, moisturized nutrient feed with the alginate/gelatin blend and deionized water. This provides an aqueous blend which includes the hydrocolloid gel. The pH of the aqueous blend is adjusted to about 12. The oil-coated, moisturized nutrient feed is encapsulated in the gel-coated matrix, such as the alginate/gelatin matrix, by cross linking the gel. In the case of the alginate or alginate/gelatin matrix, the matrix is crossed linked ionically with a multivalent cation ion such as Ca²⁺ from a salt such as calcium chloride in an aqueous bath of the salt. Specifically, the gel may be crosslinked by extruding or atomizing the oil-coated, nutrient feed in polymer blend into an aqueous solution of multivalent ions such as from about 5 to about 30 weight percent calcium chloride. This forms the product and coats it with the crosslinking agent to crosslink the gel via a crosslinking reaction to provide particles of oil-coated, moisturized nutrient feed. The oil forms an inner coating and the crosslinked gel forms an outer coating for the moisturized nutrient feed.

The encapsulated feed is sieve separated into desired size, such as from about 5 microns to particles having a length of about 6 inches and a diameter of about 2 inches. The resulting particles of oil-coated, moisturized nutrient feed then are dipped into the liquid antimicrobial as described above. After dipping, the particles are drained of excess liquid antimicrobial, such that the feed comprises from about 0.05 to about 4 weight percent antimicrobial. This permits the liquid antimicrobial to coat the surface of the crosslinked gel to provide the encapsulated feed with an antimicrobial environment, but does not make the composition flowable where the feed is suspended in a liquid medium.

The particulate solid coated feed of the invention may be made by a process that produces a feed that has a low buoyancy such that the feed sinks towards the bottom of an aqueous environment. Alternatively, the particulate solid coated feed can be made by a process that produces a feed with a buoyancy effective for providing a feed particle that floats or suspends in an aqueous environment.

A particulate solid coated feed, having a high or low buoyancy, is prepared initially by blending dry nutrient particulate powder feed having a particle size of less than about 1000 microns with an oil to form an oil enrobed nutrient particulate. The dry particulate solid powder feed includes the ingredients as described and may also include endo-probiotic and/or ecto-probiotic bacteria in the amounts described. The dry nutrient particulate powder feed and oil are blended in amounts effective for providing a particulate solid coated feed with amounts of feed, oil and endo-probiotic and/or ecto-probiotic bacteria as indicated above.

The oil enrobed nutrient particulate is blended with a gel to form a nutrient gel mixture. The gel may be a hydrocolloid gel such as alginate or a blend of alginate, such as sodium alginate and polypeptides or proteins such as gelatin, or a blend of alginate and gelatin. The gel is blended in warm water and then blended with the oil enrobed nutrient particulate. The oil enrobed nutrient particulate and gel and water are blended together in amounts effective for providing a particulate solid coated feed with amounts of feed, oil, endo-probiotic and/or ecto-probiotic bacteria, gel, and water as indicated above.

To form a particulate solid coated feed with lower buoyancy, the nutrient gel mixture is extruded into a crosslinking salt solution. The crosslinking salt solution may be a aqueous solution of multivalents ions such as from about 5 to about 30 weight percent calcium chloride. This results in crosslinking of the gel to generally form a particle with an outer crosslinked coating and an inner oil coating.

To form a particulate solid coated feed with a higher buoyancy, a gas is injected into the nutrient gel mixture prior to extrusion into the crosslinking solution. A gas, such as nitrogen, is fed under pressure of about 60 to about 110 psi into an air injector to blend gas into the nutrient gel mixture prior to extrusion. Gas is blended into the nutrient gel mixture to provide the particulate with a buoyancy such that the particulate solid coated feed has a specific gravity of less than about 1.0.

After forming a feed particulate in the crosslinking solution, feed particulate is separated from the crosslinking solution and sized. The feed particulate is contacted with an antimicrobial solution as described above, typically by dipping.

The composition of the invention includes the various components as set forth below.

| Component | % of Final Product |
|---|---|
| Endo-probiotic | 0.1-5.0 |
| (in encapsulated | |
| feed) when used | |
| Propylene Glycol | 0.05-4 |
| Antimicrobial Salt | 2-16 |
| (CaCl₂, NaCl) | |
| Feed | 15-70 |
| Oil | 3-30 |
| Emulsifiers | |
| “Santone” | 0-2.0 |
| Lecithin | 0-5.0 |
| Antioxidant | 0-150 ppm |
| “Rendox” | |

The following examples illustrate methods for carrying out the invention and should be understood to be illustrative of, but not limiting upon, the scope of the invention which is defined in the appended claims.

### EXAMPLE 1

### Processing of Feed—Sinking Version

Dry ingredients, including nutrients, vitamins, minerals and dry probiotics are blended together until uniform in a ribbon mixer. Dry ingredients are ground as needed to reduce particle size below 1000 microns. Fish oil and/or other oils/liquids are added to this mixture, and further blended to uniformity. This material is held for later addition.

Using a liquid blender, warm water (40-80° C.) is mixed with gelatin and alginate. This polymer blend is mixed until uniform. The above nutrient blend is added, at a ratio of approximately 20:80 to 80:20 (nutrient blend: polymer blend) into the polymer blend, and mixed until uniform.

This nutrient/polymer blend is fed into a positive displacement pump, and through an orifice or multiple orifices into a solution of calcium salt. The calcium solution (9-29% CaCl) is under agitation and upon coming into contact with the solution, the nutrient/polymer blend becomes cross-linked. The mixer, which is used to agitate the calcium solution, also breaks the now cross-linked strings of nutrient/polymer into smaller particles. Depending on the amount of time of agitation, the piece size can be regulated. After a short retention time, the nutrient pieces are pumped with the calcium solution into a set of screens to be classified by size. Oversized pieces can be recycled into the calcium solution for further agitation and size reduction. Calcium solution, which has been separated from the nutrient pieces, is returned to the original solution. The process continues until the entire batch of nutrient/polymer blend has been pumped through the orifice and contacted with the calcium solution.

A liquid preservative solution is prepared by blending 10-50% propylene glycol and 50-90% CaCl solution. The sized and screened nutrient particles are dipped in this preservative solution to coat individual pieces. Approximately 2-3% weight gained is observed in this dipping step. The particles are allowed to further drain and are then packaged in a plastic bag inside a corrugated box.

### EXAMPLE 2

### Processing of Feed—Floating Version

Dry ingredients, including nutrients, vitamins, minerals and dry probiotics are blended together until uniform in a ribbon mixer. Dry ingredients are ground as needed to reduce particle size below 1000 microns. Fish oil and/or other oils/liquids are added to this mixture, and further blended to uniformity. This material is held for later addition.

Using a liquid blender, warm water (40-60° C.) is mixed with gelatin and alginate. This polymer blend is mixed until uniform. The above nutrient blend is added, at a ratio of approximately 20:80 to 80:20 (nutrient blend: polymer blend) into the polymer blend, and mixed until uniform.

This nutrient/polymer blend is fed into a positive displacement pump, and through an in-line emulsifier/in-line mixer equipped with an air injector. Nitrogen gas is fed under pressure into the air injector, and the emulsifier/in-line mixer blends the gas into the nutrient/liquid blend. Sufficient quantities of nitrogen are added to alter the density of the mixture. This nutrient/polymer blend with nitrogen continues to be pumped through an orifice or multiple orifices into a solution of calcium salt. The calcium solution (9-29% CaCl) is under agitation and upon coming into contact with the solution, the nutrient/polymer blend becomes cross-linked. The mixer, which is used to agitate the calcium solution, also breaks the now cross-linked strings of nutrient/polymer into smaller particles. Depending on the amount of time of agitation, the piece size can be regulated. After a short retention time, the nutrient pieces are pumped with the calcium solution into a set of screens to be classified by size. Oversized pieces can be recycled into the calcium solution for further agitation and size reduction. Calcium solution, which has been separated from the nutrient pieces, is returned to the original solution. The process continues until the entire batch of nutrient/polymer blend has been pumped through the orifice and contacted with the calcium solution.

A liquid preservative solution is prepared by blending 10% propylene glycol and 90% CaCl solution (25% CaCl in water). The sized and screened nutrient particles are dipped in this preservative solution to coat individual pieces. Approximately 2-3% weight gained is observed in this dipping step. The particles are allowed to further drain and are then packaged in a plastic bag inside a corrugated box.

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. A foodstuff which is effective for feeding aquatic life, the foodstuff comprising:
an enrobed particulate comprising a particulate nutrient feed which has at least about 20 weight percent water, an inner oil coating comprising an edible unsaturated oil having a melting point of below about 29 degrees C. coating the particulate nutrient feed;
an outer coating enrobing the inner oil coating; and
a liquid antimicrobial agent,
the outer coating comprising a gel which is complexed or crosslinked to an extent which is effective to contain the oil-coated feed in an aqueous environment, the liquid antimicrobial agent being in an amount which is effective for providing a shelf life for the foodstuff of at least about 6 months, but which does not make the foodstuff a flowable liquid.

2. The foodstuff as recited in claim 1, wherein the antimicrobial is selected from the group consisting of propylene glycol, glycerol, propionic acid, an ammonium salt of propionic acid, a calcium salt of propionic acid, a sodium salt of propionic acid, acetic acid, a calcium salt of acetic acid, a sodium salt of acetic acid, citric acid, a calcium salt of citric acid, a sodium salt of citric acid, phosphoric acid, sorbic acid sodium benzoate, potassium benzoate, calcium benzoate, sorbic acid, potassium sorbate, sodium benzoate and mixtures thereof.

3. The foodstuff as recited in claim 1, wherein the outer coating comprises a crosslinked blend comprising alginate and protein.

4. The foodstuff as recited in claim 3 wherein the unsaturated edible oil is selected from the group consisting of fish oil, cotton seed oil, peanut oil, soybean oil, sunflowerseed oil, palm oil, coconut oil, rapeseed oil, corn oil, olive oil and mixtures thereof.

5. The foodstuff as recited in claims 1 or 2 wherein the outer coating comprises a crosslinked blend comprising alginate and gelatin.

6. The foodstuff as recited in claim 4, wherein the nutrient feed comprises a particulate feed mixed with an endo-probiotic bacteria, ecto-probiotic bacteria, and mixtures of endo- or ecto-probiotic bacterial.

7. The foodstuff as recited in claim 1 wherein the unsaturated edible oil is selected from the group consisting of fish oil, cotton seed oil, peanut oil, soybean oil, sunflowerseed oil, palm oil, coconut oil, rapeseed oil, corn oil, olive oil and mixtures thereof.

8. A particulate foodstuff which is effective for feeding aquatic life, the particulate foodstuff comprising:
an enrobed particulate foodstuff in an antimicrobial environment,
the enrobed particulate foodstuff comprising a particulate nutrient feed which has from about 20 to about 70 weight percent water, based on the weight of the particulate foodstuff, an inner oil coating comprising from about 3 to about 30 weight percent, based on the weight of the particulate foodstuff, of an edible unsaturated oil having a melting point of below about 29 degrees C. coating the particulate nutrient feed, an outer coating enrobing the inner oil coating, the outer coating comprising from about 0.5 to about 8 weight percent, based on the weight of the particulate foodstuff, of a gel which is complexed or crosslinked to an extent which is effective to contain the oil-coated feed in an aqueous environment,
the antimicrobial environment comprising an antimicrobial agent in an amount which is effective for providing a shelf life for the foodstuff of at least about 6 months, but which does not make the foodstuff a flowable liquid, the antimicrobial comprising an antimicrobial selected from the group consisting of propylene glycol, glycerol, propionic acid, an ammonium salt of propionic acid, a calcium salt of propionic acid, a sodium salt of propionic acid, acetic acid, a calcium salt of acetic acid, a sodium salt of acetic acid, citric acid, a calcium salt of citric acid, a sodium salt of citric acid, phosphoric acid, sorbic acid sodium benzoate, potassium benzoate, calcium benzoate, sorbic acid, potassium sorbate, sodium benzoate and mixtures thereof.

9. The foodstuff as recited in claim 8, wherein the outer coating is a crosslinked/alginate gelatin gel.

10. The foodstuff as recited in claim 8 wherein the antimicrobial is selected from the group consisting of propylene glycol, glycerol, propionic acid, water soluble salts of propionic acid, acetic acid, water soluble salts of acidic acid, citric acid, water soluble salts of citric acid, phosphoric acid, sorbic acid, water soluble salts of sorbic acid and mixtures thereof.

11. The foodstuff as recited in claims 8, 9 or 10, wherein the particulate nutrient feed includes from about 0.1 to about 5.0 weight percent ecto-probiotic bacteria, endo-probiotic bacteria, and mixtures thereof based upon the weight of the particulate foodstuff.

12. A foodstuff which is effective for feeding aquatic life, the foodstuff comprising:
an enrobed particulate comprising a particulate nutrient feed which has at least about 20 weight percent water, an inner oil coating comprising an edible unsaturated oil having a melting point of below about 29 degrees C. coating the particulate nutrient feed;
an outer coating enrobing the inner oil coating; and
a liquid antimicrobial agent,
the outer coating comprising a gel which is complexed or crosslinked to an extent which is effective to contain the oil-coated feed in an aqueous environment, the liquid antimicrobial agent being in an amount which is effective for providing a foodstuff with an aerobic total plate count of less than about 10⁷ total microbes per gram of foodstuff after about 6 months, but which does not make the foodstuff a flowable liquid.

13. The foodstuff as recited in claim 12, wherein the antimicrobial is selected from the group consisting of propylene glycol, glycerol, propionic acid, an ammonium salt of propionic acid, a calcium salt of propionic acid, a sodium salt of propionic acid, acetic acid, a calcium salt of acetic acid, a sodium salt of acetic acid, citric acid, a calcium salt of citric acid, a sodium salt of citric acid, phosphoric acid, sorbic acid sodium benzoate, potassium benzoate, calcium benzoate, sorbic acid, potassium sorbate, sodium benzoate and mixtures thereof.

14. The foodstuff as recited in claim 12, wherein the outer coating comprises a crosslinked blend comprising alginate and protein.

15. The foodstuff as recited in claim 14 wherein the unsaturated edible oil is selected from the group consisting of fish oil, cotton seed oil, peanut oil, soybean oil, sunflowerseed oil, palm oil, coconut oil, rapeseed oil, corn oil, olive oil and mixtures thereof.

16. The foodstuff as recited in claims 12 or 13 wherein the outer coating comprises a crosslinked blend comprising alginate and gelatin.

17. The foodstuff as recited in claim 15, wherein the nutrient feed comprises a particulate feed mixed with an endo-probiotic bacteria, ecto-probiotic bacteria, and mixtures of endo- or ecto-probiotic bacterial.

18. The foodstuff as recited in claim 12 wherein the unsaturated edible oil is selected from the group consisting of fish oil, cotton seed oil, peanut oil, soybean oil, sunflowerseed oil, palm oil, coconut oil, rapeseed oil, corn oil, olive oil and mixtures thereof.

19. A foodstuff which is effective for feeding aquatic life, the foodstuff comprising:
from about 15 weight percent to about 70 weight percent, based on the weight of the foodstuff, of a particulate nutrient feed;
from about 3 weight percent to about 30 weight percent, based on the weight of the foodstuff, oil;
from about 0.5 weight percent to about 8 weight percent, based on the weight of the foodstuff, gel;
from about 2 weight percent to about 16 weight percent, based on the weight of the foodstuff, crosslinking salt;
from about 0.5 weight percent to about 4 weight percent, based on the weight of the foodstuff, antimicrobial;
from about 0.1 weight percent to about 5 weight percent, based on the weight of the foodstuff, endo-probiotic bacteria; and
from about 20 weight percent to about 70 weight percent, based on the weight of the foodstuff, water.

20. A method of making a foodstuff which is effective for feeding aquatic life, the method comprising:
blending a dry nutrient particulate powder feed having a particle size of less than about 1000 microns with an oil to form an oil enrobed nutrient particulate;
blending the oil enrobed nutrient particulate with a gel to form a nutrient gel;
injected an inert gas into the nutrient gel;
extruding the nutrient gel into a crosslinking salt solution to form a feed particulate;
separating the feed particulate form the crosslinking salt solution;
contacting the feed particulate with an anitmicrobial agent;
and draining excess antimicrobial agent from the particulate.

21. A method of making a foodstuff which is effective for feeding aquatic life, the method comprising:
blending a dry nutrient particulate powder feed having a particle size of less than about 1000 microns with an oil to form an oil enrobed nutrient particulate;
blending the oil enrobed nutrient particulate with a gel to form a nutrient gel;
extruding the nutrient gel into a crosslinking salt solution to form a feed particulate;
separating the feed particulate form the crosslinking salt solution;
contacting the feed particulate with an anitmicrobial agent;
and draining excess antimicrobial agent from the particulate.

22. A method for feeding aquatic life comprising adding a foodstuff to an aquatic environment, the foodstuff including an enrobed particulate comprising a particulate nutrient feed which has at least about 20 weight percent water, an inner oil coating comprising an edible unsaturated oil having a melting point of below about 29 degrees C. coating the particulate nutrient feed;
an outer coating enrobing the inner oil coating; and
a liquid antimicrobial agent,
the outer coating comprising a gel which is complexed or crosslinked to an extent which is effective to contain the oil-coated feed in an aqueous environment, the liquid antimicrobial agent being in an amount which is effective for providing a shelf life for the foodstuff of at least about 6 months, but which does not make the foodstuff a flowable liquid.
